(19) United States
(12) Patent Application Publication
(10) Pub. No.: US 2013/0097246 A1
(43) Pub. Date: Apr. 18, 2013

(54) MULTILOCAL IMPLICIT SOCIAL NETWORKING

(71) Applicant: Cult, Inc., San Francisco, CA (US)

(72) Inventors: Gon ZIFRONI, Brussels (BE); Koen DESCHACHT, Antwerpen (BE)

(73) Assignee: CULT, INC., San Francisco, CA (US)

(21) Appl. No.: 13/649,838

(22) Filed: Oct. 11, 2012

Related U.S. Application Data
(60) Provisional application No. 61/546,409, filed on Oct. 12, 2011.
(60) Provisional application No. 61/592,472, filed on Jan. 30, 2012.

(51) Int. Cl. G06F 15/16

(52) U.S. Cl. 709/204

(57) ABSTRACT

In a first embodiment of the present invention, a method for multilocal implicit social networking is provided, the method comprising: receiving an indication of a first geolocation of a first user; accessing a representation of a multilocal service, wherein the representation includes a plurality of locations, including locations different than the first geolocation, that are related to the multilocal service; and when it is determined that the first geolocation matches one of the plurality of locations in the representation of the multilocal service, adding a social networking link between the user and the multilocal service.

### CROSS-REFERENCE TO RELATED APPLICATIONS

This patent application claims priority under 35 U.S.C. §119(e) to U.S. Provisional Patent Application Ser. No. 61/546,409 entitled “MULTILOCAL IMPLICIT SOCIAL NETWORKING” by Zifroni et al., filed Oct. 12, 2011 and to U.S. Provisional Patent Application Ser. No. 61/592,472 entitled “MULTILOCAL IMPLICIT SOCIAL NETWORKING” by Zifroni et al., filed Jan. 30, 2012, both of which are incorporated by reference in their entirety for all purposes.

### BACKGROUND OF THE INVENTION

1. Field of the Invention

The present invention relates to social networking. More particularly, the present invention relates to implicit social networking via multiple locations.

2. Description of the Related Art

Social networking involves connecting people via online networking platforms. A social networking service is the online service or site that focuses on the building of social networks. People can allow others into their “social network” using a number of different criteria, some of which vary based on the platform. For example, users may group their friends and family members in their social network, or work contacts, or people they do not know but with who they share something in common (such as for example people who share similar interests), or any combination of the above and other factors. Some sites, for example, may be geared more towards business contacts, whereas others may be geared towards personal contacts. The concept, however, is the same—connecting people through the Internet.

The main types of social networking services contain social categories (e.g., classmates, friends, business contacts), means to connect with contacts (usually with self-description pages) and a recommendation system linked to trust. Popular methods now combine many of these, with Facebook, Google+, and Twitter widely used worldwide.

Social networking can be viewed as an extension of end-to-end telecommunication because it allows groups of people to form around interests, activities, and locations they have in common without previous knowledge of each other. By exposing a profile and networking relations to others, a user of a social network publicly expresses (or less publicly depending on privacy settings and who has access rights), the user's interests, taste, intents, activities, thoughts, social context or any other type of information. All of this gives other users opportunities to act on this information using a variety of social interactions with the user. For example, other users may attempt to join the user's social network by sending an invitation to join the social network of a particular user (sometimes known as “friending”, “following” or “liking”). Typically people use social networks to form relations out of common interests, friendships, collaboration, shared industry, current activity, having met in person, sharing the same experience, having related habits, or having similar taste, or a combination of these factors and including other factors.

The difference between social networking and older types of networking such as direct end-to-end telecommunication like the telephone or email is that the profile and relational information (such as contacts, friends, followers or other type of relations) is made accessible to other users to aid users forming new social links (relations) in a faster and easier fashion. In the past, while some level of relational information used to be tracked (such as in a phone book or an email contact list), this information was not exposed and shared with other users within the system as core functionality of the system.

A problem that is encountered, however, in social networking is that it can be very labor intensive for a user to establish social network connections with other users. The user must figure out whom he or she wants or needs to connect with in a given context in order to get information relevant to particular needs using her or his social relations. Social network connections need to be explicitly made and unmade when the user wants to change her or his social context to improve the relevancy of her or his communication. The relevancy in question relates to both inbound communication, meaning the information received from other users that are in her or his social network, and outbound communication, as in which other users would be interested in her or his social networking activities. Context could include a variety of factors, including location, time, activity, etc, but the users must make the connections themselves (using explicit functions of the user interface provided by the social networking service, for example using a mobile device or a personal computer or laptop). Moreover, users generally do not want to establish links that they may later need to unmake due to a change in the context (for example, if the previous link becomes no longer relevant). The rapid change of context of users and the corresponding change in user needs requires different sets of relations by which users get relevant information from other users. Thus, the main problem with typical social networking sites is that there are limited occurrences at which a significant quantity of relations can be made. The user essentially must make connections one at a time, and only after evaluating the merits of each potential link.

There are various recommendation systems that are able to suggest new users to a user, for example using their existing social connections to recommend users who have similar social connections or are socially close to the user, but these techniques still require users to act on those recommendations using an explicit user interface for sending a friend request, following another user or otherwise creating the relation.

Another problem with existing social networking sites is the strength of relations among users as it relates to their relevance and authenticity, due to the volatile nature of social networking. Because social relations are volatile and may not persist over time, there is a lower degree of accountability and therefore a lower expectation of value. While long-lasting relationships are maintained by trust being gained over time via, for example, explicit engagement among users, short-term relations are weaker and less relied upon. Yet these relations have a greater potential to bring about new information that would otherwise be outside of reach. Surfacing interesting weak-tie relations is highly valuable and often pertains to a particular interest or context. In other words various subsets of weak ties are relevant for various interest and/or in different contexts and/or combination thereof.

At an individual level these problems can affect personal privacy. For example, users can abuse other users' privacy by illicitly attempting to gain access to a service. Another example is users can provide false or irrelevant information to others without consequence, and hence join a user's network under false pretenses. This can cause a loss of trust of the social networking site, especially with respect to short term, newly added or weaker social networking contacts.

### SUMMARY OF THE INVENTION

In a first embodiment of the present invention, a method for multilocal implicit social networking is provided, the method comprising: receiving an indication of a first geolocation of a first user; accessing a representation of a multilocal service, wherein the representation includes a plurality of locations, including locations different than the first geolocation, that are related to the multilocal service; and when it is determined that the first geolocation matches one of the plurality of locations in the representation of the multilocal service, adding a social networking link between the user and the multilocal service.

In a second embodiment of the present invention, an implicit social networking service is provided, comprising: memory storing a representation of a multilocal service wherein the representation includes a plurality of locations that are related to the multilocal service; a geolocation interface designed to receive geolocations from devices operated by users; a multilocal service matcher designed to determine whether geolocations from devices operated by users match one of the plurality of locations in the representation of the multilocal service and automatically add a social networking link between users of devices having matching geolocations and the multilocal service.

In a third embodiment of the present invention, a system is provided comprising: a plurality of devices located in different geolocations; an implicit social networking service designed to receive information regarding the geolocations of the plurality of devices and to group the plurality of devices into a single social grouping based upon the geolocations, and to automatically add social networking links between users of the devices in the social grouping.

### BRIEF DESCRIPTION OF THE DRAWINGS

FIG. 1 is a diagram illustrating the concept of multilocations in accordance with an embodiment of the present invention.

FIG. 2 is a diagram illustrating the representation of multilocations in accordance with an embodiment of the present invention.

FIG. 3 is a diagram illustrating an example user interface showing multiple multilocations available to a user in a particular area in accordance with an embodiment of the present invention.

FIG. 4 is a diagram illustrating an example of how locations are stored for a particular social networking group.

FIG. 5 is a flow diagram illustrating a method for multilocal implicit social networking in accordance with an embodiment of the present invention.

FIG. 6 is a block diagram illustrating implicit social networking service in accordance with an embodiment of the present invention.

FIG. 7 is an example user interface in accordance with an embodiment of the present invention.

FIG. 8 is another example user interface in accordance with an embodiment of the present invention.

FIG. 9 is a diagram illustrating an interface for using a current geolocation as input to an interface to aid in selecting appropriate nearby locations to assign to a new multilocal social network related to the location, or to other locations automatically in accordance with an embodiment of the present invention.

FIG. 10 is a diagram illustrating the spawning of multilocal services in accordance with an embodiment of the present invention.

FIG. 11 is a diagram illustrating the spawning of multilocal services in accordance with another embodiment of the present invention.

FIG. 12 is a diagram illustrating a user interface in accordance with another embodiment of the present invention.

FIG. 13 is a diagram illustrating a system in accordance with an embodiment of the present invention.

FIG. 14 is a diagram illustrating an algorithm for computing the attention-based score in accordance with an embodiment of the present invention.

FIG. 15 is a diagram illustrating a system in accordance with another embodiment of the present invention.

### DETAILED DESCRIPTION OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

### Overview

In an embodiment of the present invention, location-based implicit social networking is provided. An embodiment of the present invention further extends this functionality by correlating a plurality of different locations with a single grouping of locations rather than relying on a single location. This extends the spatial basis on which an implicit social network can infer the dynamic formation of user relations to a broader footprint by associating multiple locations that can be distributed globally and do not need to be co-located or located in proximity to each other. By using a plurality of associated locations (the set is also known as a “multilocation”), the chance of users of being connected in a relevant way to other users increases, because of the greater distribution and footprint that multiple locations can cover at the same time. Users, for example, will not be required to be at the same location in order for a location-based relation to be implied—they can be at multiple related locations. Because locations are correlated in a way that is meaningful for users, it allows them to make more frequent, and more valuable, connections.

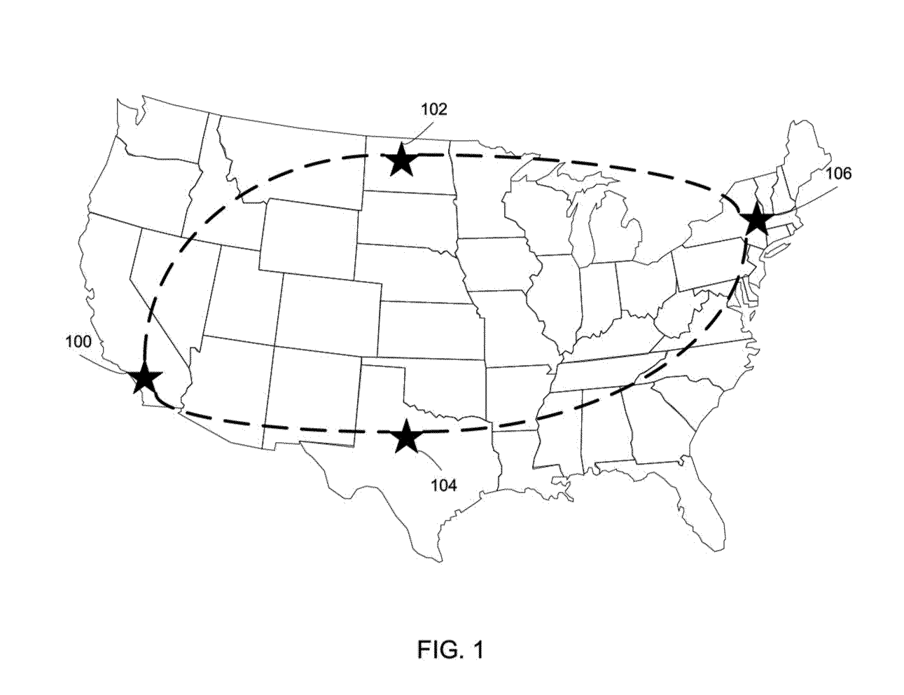

FIG. 1 is a diagram illustrating the concept of multilocations in accordance with an embodiment of the present invention. Here, a user at a location 100 in California may be linked to a user at location 102 in Nebraska, a user at location 104 in Texas, and a user at location 106 in New York. Locations 100, 102, 104, and 106 are part of the same “multilocation,” For example, each of these locations 100, 102, 104, 106 may be locations of a particular chain retailer. Thus, despite the fact that the users at these various locations may not ever have been to the other locations, all the users may be linked by a single social networking “multilocation” and thus new social connections are potentially made despite no apparent connection between the users other than being located at locations grouped into the same multilocation.

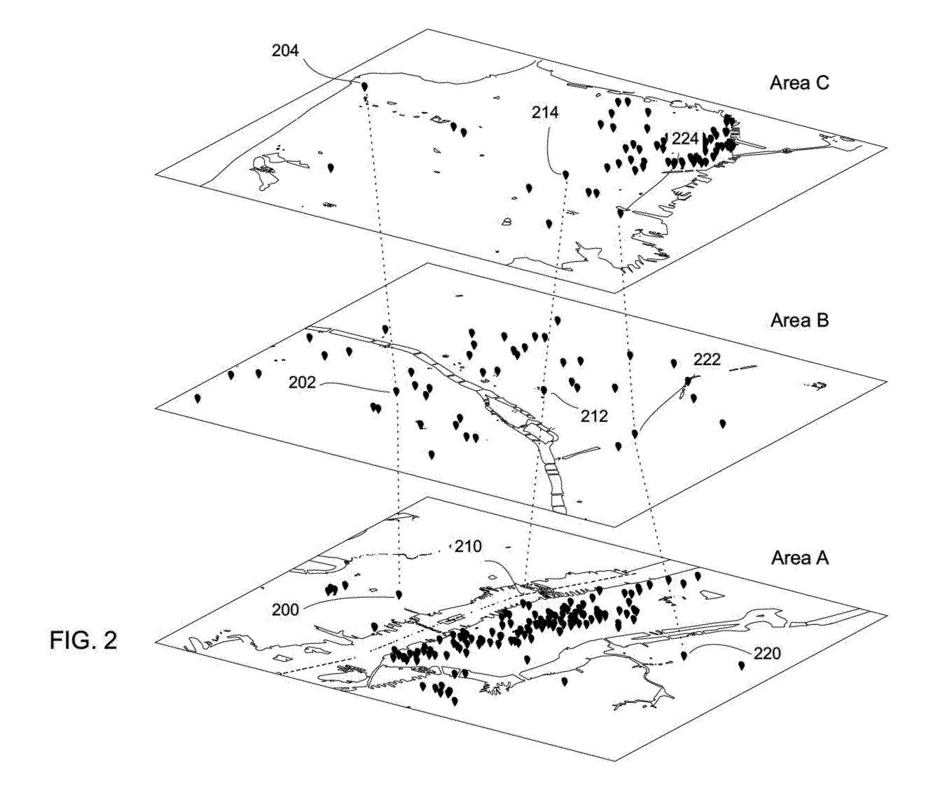

FIG. 2 is a diagram illustrating the representation of multilocations in accordance with an embodiment of the present invention. As can be seen, points 200, 202, and 204 may be linked, despite the fact that they are in different areas (Area A, Area B, and Area C, respectively) because they are part of the same multilocation. In the same fashion points 210, 212 and 214 are part of another multilocation, and points 220, 222 and 224 are part of yet another multilocation.

For purposes of the present invention, a social network is considered to be implicit when social interactions such as the ones related to relationships (e.g., friend requests, invites, follows, etc.) do not need to be explicitly made by users but are rather implied by other factors, such as geolocation, concurrent activity among users, common interests or purchases, the visiting of another user's profile, text correlations in messages, the sending of direct messages from one user to another user, viewing of another user's content, mentioning of another user, forwarding of another user's profile to a third user for purpose of referral, etc., and wherein the system assumes such a relationship. The factors used in this analysis can be any kinds of features the systems needs to extract using analytics in order to find and assume commonalities among users and imply relations. The factors themselves can be combined and have different weights at which they affect the score of the implied relation. The relations can be weighted using that score for purposes of signaling the relevancy of the relationship in the context of other relationships. For example, the weight can be applied to a time factor at the issue of which the relationship is less or no longer relevant, based on the time factors of other relationships. In other words, the time factor affects the appreciation or depreciation of the weighting in proportion to time factors of other relations the user has. For example, during a given week the weight of a relation with another user can depreciate, but it would only be meaningful if the weight of the other relations do not depreciate at the same time (e.g., during the same week). Thus, the relation in question is becoming less relevant in proportion to other concurrent relations.

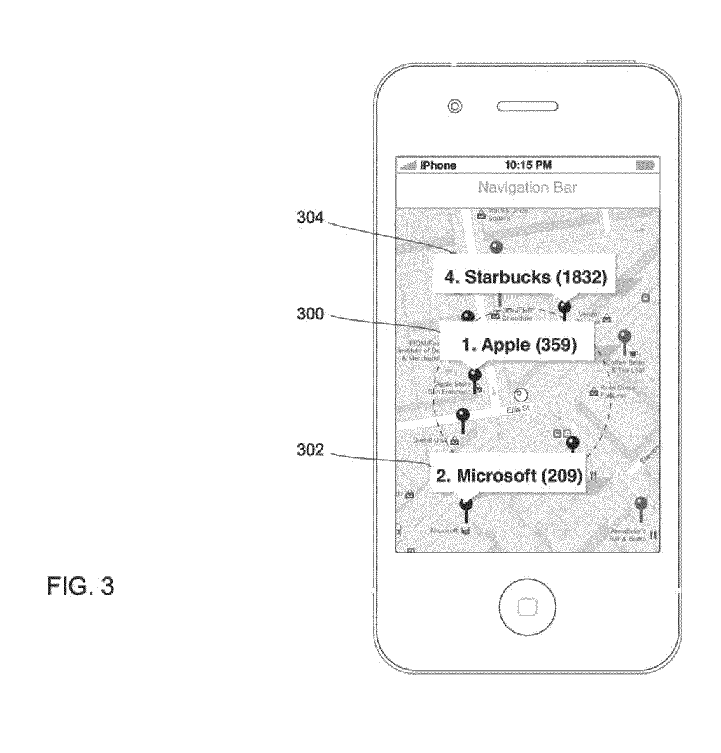

In an embodiment of the present invention, users can be implicitly related or connected to each other even as they are (concurrently or not) in different locations, because these locations are part of the same set of similar or otherwise correlated locations (the same multilocation). FIG. 3 is a diagram illustrating an example user interface showing multiple multilocations available to a user in a particular area in accordance with an embodiment of the present invention. The user here may be a part of at least four “multilocation” groups: an Apple group, a Microsoft group, a Sony group, and a Starbucks group. In this figure, it can be seen that a location 300 for the Apple group is available. Presumably there will be many other Apple locations available throughout the country (and world), but on this particular map the one that is available in proximity of this location is depicted. Likewise, multilocations are available for the Microsoft group (302) and the Starbucks group (304). Notably, no multilocations is depicted for the Sony group, presumably because there just doesn't happen to be any multilocations in the Sony group within the map area currently being displayed.

The number of locations that are in a set directly multiplies the chances users have to be in touch with other users, as compared to if they were using a location-based service that relates users on a per single location basis, because more locations are on the path, and in reach, of more users. For example, the system could detect that a user is currently located on a trail in an open space preserve in Palo Alto, Calif. while another user is currently located on a trail in an open space preserve in Rochester, N.Y. An implied social networking link can be established between these two users, who apparently both share the interest of hiking (or biking) in open space preserves, despite the fact that both users are located across the country, and perhaps have never visited each other's states. As such, the social networking link is built based on location, despite the fact that the location is not, and has never been, shared and despite the fact that both users need not previously be in contact or otherwise have had previous knowledge of each other.

The greater the number of associated locations, the greater the chance to meet others, because more users can be present, concurrently or not, across a plurality of locations than if the system merely used a single location. The stronger the correlation among locations of the same set, the stronger the potential correlation for users, making the implied relations more relevant, useful, and meaningful to users.

In an embodiment of the present invention, automatic or manual processes are provided for creating multilocal implicit social networks, and multilocal services in general. For purposes of this document, a service is an online service that can be accessed using an IP address, a domain name, a uniform resource locator (URL) path, a directory on a service, a port, a socket, or any similar identifier, and provide any kind of functionality, value-add, service, communication service, or experience to users that, for example, connects users together, provides a chat room, forum, questions and answers service (Q&A), website, game or other media, e-commerce website, trading or bidding service, real-estate website, city guide, company private communication such as a virtual private network (VPN), data archive, video conference, synchronous or asynchronous chats, voice or video calls, or the like.

Additionally, user interfaces and algorithms that facilitate creation and management of such services may be provided. For example, one method uses the user's current geolocation (as determined from, for example, a global positioning system, or GPS), to algorithmically determine a set of related locations of the new service or multilocal implicit social network. Another method uses a search function, for example a map or list, to display the results of matching locations to a search query or to a geolocation or address the user specifies. These methods are further described below in the sections labeled “Creating Multilocal Services” and “User Interface for Creating Multilocal Services.”

For purposes of this document, a geolocation is a physical location that can be expressed as a latitude and longitude coordinates, optionally with one or more other dimensions such as altitude or height, as an urban unit or reference with another other method of determining a position in a system. It can have a range so as to include a set of geolocations in proximity as defined by the range. In addition the system can also work using other types of coordinates to represent an address, or location, in a space of any type with any type and number of dimensions or any other form of representation that needs not be limited to a geographic space. For example a location can be a virtual memory address on a computer, a position in a virtual game, and so on. In addition, locations of different kinds can be part of the same multilocation set, each described according to their own type of coordinates. Other factors than the coordinates can be used to determine the correlation factor.

A location is a geo-located entity for which some data can be found from one or more sources, or for which one or more users contributed data. The data can be, for example, a name, a picture, a description, a link, an association, a property or set of properties characterizing the geolocation, and so on.

Furthermore, each location may have a time dimension for which it is part of the current active set of locations of the multilocal social network. In this fashion, one location can be a part of multiple sets assigned to different multilocal social networks at different times of the day, week, month, or year, or at a given date and time. Other factors can affect modifications of those times when the location is part of the active set. A location can have overlapping multilocal social networks and be part of one or more active multilocation sets at the same time.

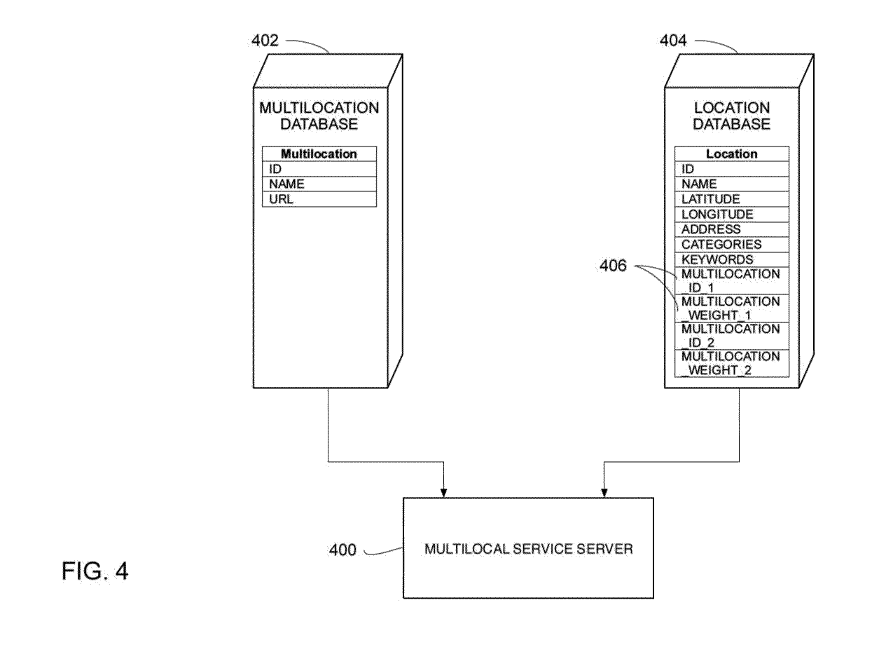

FIG. 4 is a diagram illustrating an example of how locations are stored for a particular social networking group. The multilocal service for any social networking group requires a server in 400 that stores locations and multilocations data. The multilocations database 402 contains a collection of multilocations. The location database 404 contains a collection of locations, with possibly for every location a plurality of associated information such as its coordinates (which can be but are not limited to geographic coordinates), address, name, contact information, opening hours, or any other type of information related to the particular location, as well as a one or more multilocation to which it is associated. Reference is made in 406 for each location to one or more multilocation using for each associated multilocation the identifier of the multilocation and a weight. For every multilocation a list of locations that belong to that multilocation can be computed by querying all the locations that have a reference in the location database 404 to that multilocation. Additionally, the multilocation database 402 contains one of more information further characterizing this multilocation such as the name of the multilocation, the uniform resource locator of a website of this multilocation, the date and time at which the multilocation was first created, a reference to the user that initiated the creation of the multilocation in the case that the system is configured to enable such ‘crowdsourcing’, the popularity or other ranking metrics that apply to it, or any other information that applies including information that the system or the users of the social networking group learn or gather as it evolves such as an automatic or user-generated summary of the content describing what the group is about, automatic extraction of current topics using for example latent semantic analysis or machine learning techniques.

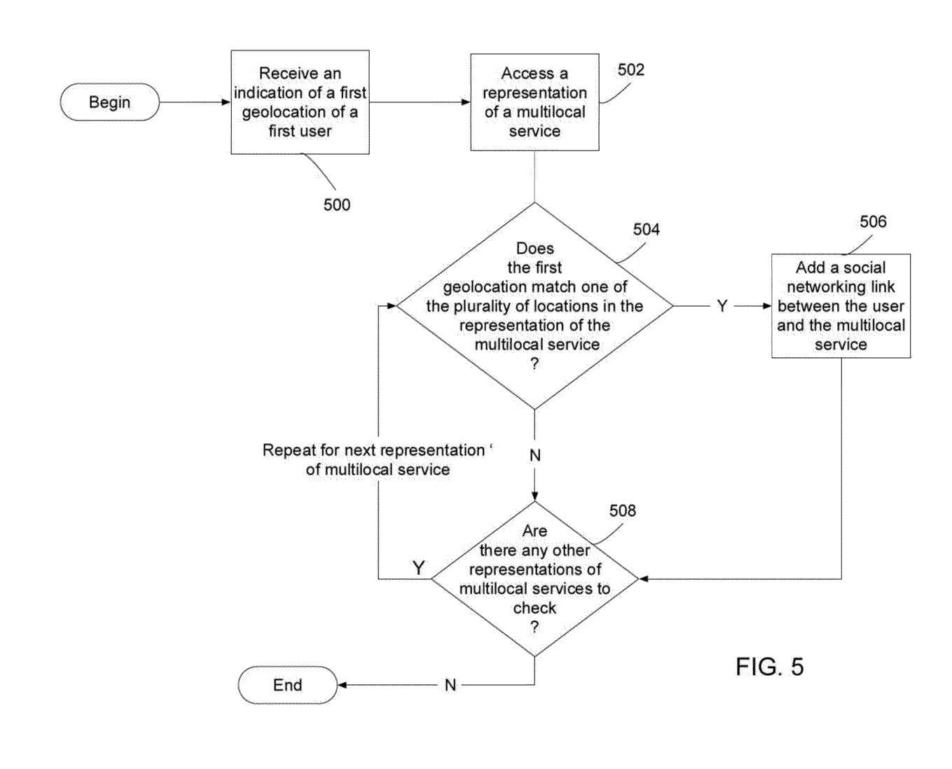

FIG. 5 is a flow diagram illustrating a method for multilocal implicit social networking in accordance with an embodiment of the present invention. At 500, an indication of a first geolocation of a first user is received. This may be performed in a number of different ways, including, for example, retrieving GPS coordinates from a GPS module of a user device, determining that the user is at a geolocation by triangulating its position using its range from one or more long-range telecommunication cell towers (for example using signal strength), or determining the user's geolocation using medium and short-range communication modules. The latter can include but are not limited to WiFi routers, RFID tag, Near-Field Communication (NFC) tag (powered or unpowered chip), BlueTooth, etc. The approach for determining and increasing the certainty of a device's geolocation can be a combination of methods (e.g. using a mesh or network of modules or devices using of homogeneous or heterogeneous communication methods). For example the system can learn the geolocation of a device over time using a variety of approaches that can be assigned different levels or ‘weight’ of certainty or trust. The learning mechanism for NFC-equipped devices, RFID-equipped, BlueTooth-equipped, Wifi-equipped devices, other such communication modules with which devices can be equipped, or a combination of those can for example follow a propagation model whereby the geolocation of one device can propagate to other nearby devices in a peer-to-peer fashion with or without user intervention. Every time a device receives location information using one or more techniques it can propagate it along with a certainty weight, verify it with other nearby devices and whereby the geolocation gets validated over time and with growing certainty and geolocation data sources using for example a multi-agent learning approach, a bayesian approach or any other collaborative filtering technique.

At 502, a representation of a multilocal service is accessed. The representation includes a plurality of locations, including locations different than the first geolocation, that are related to the multilocal service. This representation may also be known as a “multilocation.” At 504, it is determined if the first geolocation matches one of the plurality of locations in the representation of the multilocal service. If so, then at 506, a social networking link is added between the user and the multilocal service. If not, then at 508 it is determined if there are any other representations of multilocal services to check. If so, then the process at 504 is repeated for a representation of another multilocal service. If all the representations for multilocal services have been checked, then the process may end. In this case, no matching multilocal service has been found and no social networking link is added. However, in such a case, the user may elect (or the system may elect automatically) to start a new multilocal service for the user's current location.

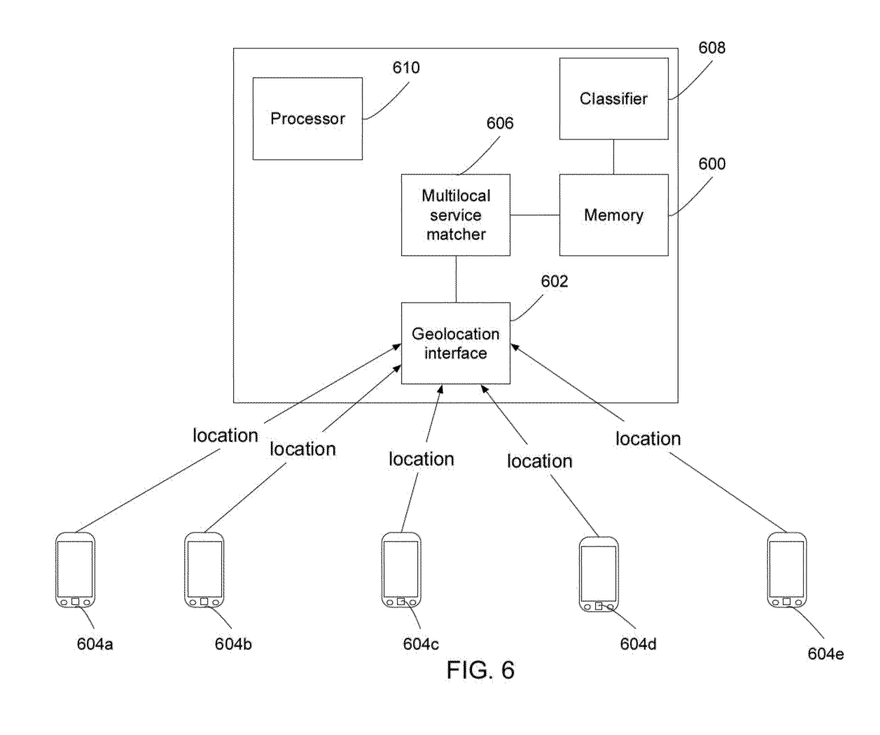

FIG. 6 is a block diagram illustrating implicit social networking service in accordance with an embodiment of the present invention. A memory 600 stores a representation of a multilocal service (the “multilocation”). A geolocation interface 602 is then designed to receive geolocations from users 604a-604e. A multilocal service matcher 606 is then designed to determine whether geolocations from devices operated by users match one of the plurality of locations in the representation of the multilocal service, and then automatically add a social networking link between users of devices having matching geolocations and the multilocal service. A classifier 608 may automatically add locations to the representation in memory 600 based upon user activities detected at geolocations reported from the devices. A processor 610 may be used to execute the various functions of the system.

In an embodiment of the present invention, the geolocation of a user is also used to authorize the user's device (and the user's identity) to be granted access to a selected multilocal social network. Thus, for example, it is not enough that the user merely states that he or she is interested in hiking, the user's location must actually be tracked as having been on trails in open space preserves in order for the implicit social networking link the be established. The selection of the multilocal social network is a process that uses the user's geolocation, the user's profile, and/or a user's manual selection. An algorithm that tracks a user's activity level can define the level of access the user is granted for accessing content of the multilocal social network with the purpose of ensuring the privacy of other users. Thus, the access level can reflect the level of engagement with the particular content of the multilocal social network. For example, it may not be enough that a user has visited one open space preserve on one occasion, the user may need to visit open space preserves on five different occasions in order for the social networking link to a “hiking group” to be implicitly made. It may not just be based on number of visits, but the amount of visits within a predefined period of time. Perhaps the group is geared towards “hardcore” hikers, and may require that the user visits open space preserves 5 times within a month in order to be granted access to the group. The duration of the user's stay at a particular location may be measured, such that, for example, a user who hikes for only an hour each visit may not have the implicit link established but a user who hikes for 8 hours each visit may be deemed “worthy” of joining the group or gaining increased access level. Different access levels can for example grant users access to more or less functionality, permissions or data.

Furthermore, in an embodiment of the present invention, a social networking link may not merely be implicitly established, but could also be implicitly unestablished. Thus, for example, if a user stops visiting open space preserves for a period of time, the user may essentially be “kicked out” of the social network group.

In another embodiment of the present invention, security methods are included to prevent fraudulent activity, such as the spamming of a multilocal social network or spoofing of geolocations. These methods can use a set of environmental metrics to determine which users are spammers or spoofers and by extension which users make legitimate use of the multilocal social network. One method measures the broadcasting times of nearby WiFi routers' SSIDs for users at a geolocation and uses that information to detect user devices that expose statistically significant dissimilarities from other user devices at the same geolocation the original user claims to be. Another method compares locally captured sound bites, with a stronger reliance on data coming from verified accounts such as sponsored, promoted, and/or paid accounts, or accounts that are otherwise verified as being legitimate for example following their track record of behavior inside or outside the system. Another method tracks the changes in the assigned device IP address and/or MAC address, the IP and/or MAC address of the router, and the geolocation. This method extracts addresses of both the device and the router. Other factors are then combined, such as determining whether the user is using a landline or a mobile device using public IP databases where companies have to publish the IP ranges they assign to landlines and mobile devices.

Other methods can also be used in combination with the methods described above to increase the security level. For example, a device IP address can be reversed to determine a geolocation in the case of a landline user, a mobile devices geolocation can be triangulated, unique security keys can be issued per device with a rolling secret to detect copying of a key to an unauthorized device, and/or jail-broken mobile devices on which unapproved software (including possible spoofing software) is installed can be detected. Another method uses pattern analysis techniques to extract features that characterize fraudulent and non-fraudulent user devices and user behaviors. Collected data points can then be used to train the pattern-based analytics engine, for example using machine-learning techniques to extract features used for detecting fraudulent activity.

### Spawning Multilocal Services

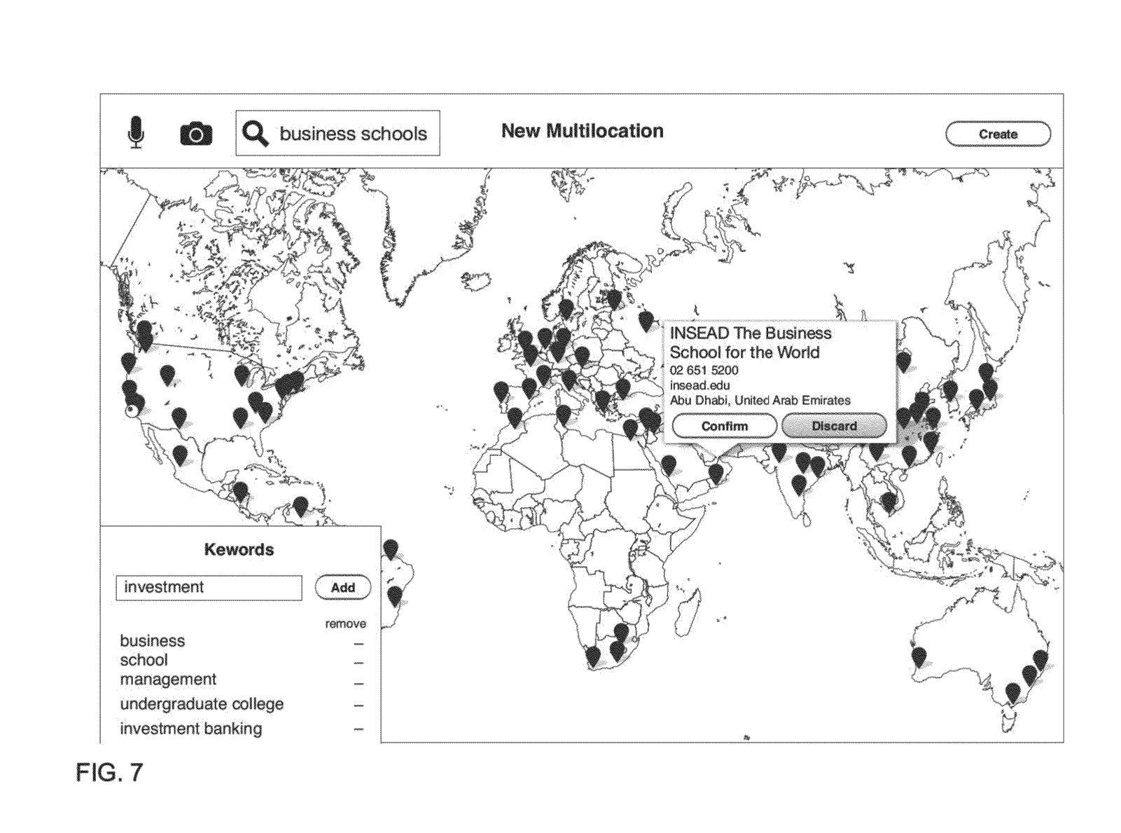

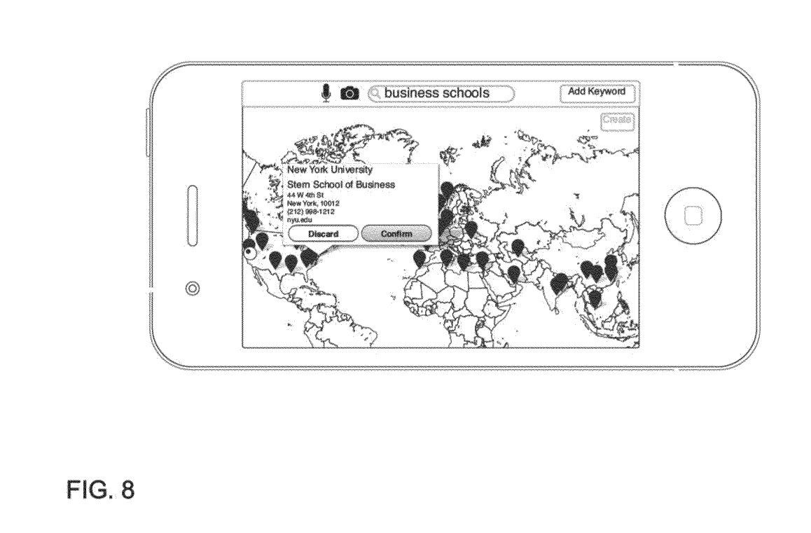

In an embodiment of the present invention, a user creates an online multilocal social network by associating to it a set of geolocations using an interface to select a plurality of geolocations that are registered as locations in multiple sources. FIG. 7 is an example user interface in accordance with an embodiment of the present invention. The interface can include search (by text query, image, video, voice, etc.), browsing categories and lists, interactive maps, or the like. Any person nearby any of the locations of the multilocal social network can be redirected or connected to a common multilocal social network. FIG. 8 is another example user interface in accordance with an embodiment of the present invention, this one geared towards a mobile environment.

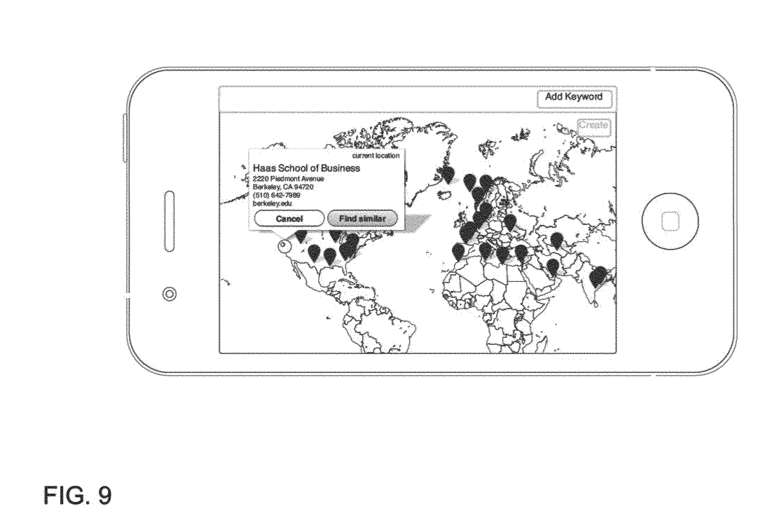

A user with a device can use his current geolocation as input to an interface to aid in selecting appropriate nearby locations to assign to a new multilocal social network related to the location, or to other locations automatically. This type of interface is depicted in FIG. 9. For example, a user's location may spawn a list of nearby points of interests, such as stores, museums, schools, hiking trails, etc. The user may then establish a new social networking group, for example, corresponding to an interest that is related to one of these points of interest. Other locations having been identified as being related to the selected location, using methods described below, could then be automatically assigned to the social networking group by the system. For example, the user may be on a street outside of a museum, 5 different retailers, 3 restaurants, and a daycare. The user may use his location as input to the interface (either by typing it in or through automatic detection of his position through, for example, a GPS module). The user then may be presented with a list of the museums, retailers, restaurants, and the daycare in his vicinity. He may then select the museum as being the location he is interested in setting up a group for. The system may recognize that this is a natural history museum and automatically add the user to a social networking group related to natural history museums. Alternatively, if no social networking group is set up for the location (or the user simply wishes to start a new one), the system may establish a social networking group and, either through knowledge previously known to the system (such as a preloaded list of natural history museums) or through further investigations (e.g., conducting a web search on natural history museums), may identify other locations that are also related to that same interest (e.g., locations of other natural history museums).

During the process of associating geolocations to multilocal social networks, the system may find related locations by automatically searching a plurality of location databases from a plurality of sources, normalize, and rank the results. The nature of the relation can either be automatically defined using an algorithm, manually set by the user using an interface, or otherwise affected by inputs from the user in question and from other users. Additionally, there can be privileges at play that grant only certain users the authority to add geolocations directly to a multilocation, if at all. For example the system can be configured to allow more or less flexibility for users to add new geolocations, as well as spatial boundaries within which it would be allowed for example in relation to the user's current or usual geolocation. To gain access to these privileges (also referred to as “permissions”) users may be required to accomplish certain tasks, be ‘members’ of the social networking group they wish to add a geolocation to or provide any other form validating their credibility. Such credibility can be gained within or inherited from outside the system itself, or a combination of both. For example it can be a representation of how trustworthy the user is according to her or his track record of activities online or offline, his social connections and their trustworthiness, or earned referrals.

The title, description, links, and other data about the location gathered from the plurality of sources can be used as combined parameters for finding other similar locations. The terms extracted from this information can be used as a search query. The user initiates a query using the current location, and data related to it extracted from multiple sources, to find similar locations. The system can apply one or a combination of standard techniques such as clustering techniques, pattern analysis, similarity measures, stochastic classifiers, etc. to the extracted data to compute which other locations should be associated to the user's current location and which should not.

This embodiment is further refined by applying a higher weight to terms directly provided by the user or otherwise explicitly indicated by the user as important. The user formulates a query using, for example, text input or voice-search that can affect the weighting of important terms from the extracted data in order to refine the query. In addition, the input can be used on its own by applying standard information retrieval techniques to find the most relevant locations for the query. Mixed approaches could combine both results to refine the resulting set of similar locations. The first approach emphasizes user intent, while the second approach can apply more or less importance to the user's intent or to the extracted terms.

This embodiment may be further refined by applying a higher weight to terms provided by the user. For example the system can automatically extract terms from current or past messages, conversations or other communication media such as for example, and not limited to, speech or video, and use these terms as a factor to supervise the process.

The process of this embodiment can involve image-based search techniques wherein the user takes a picture at the current location to find locations that have similar pictures associated to them. For example a picture featuring a painting of an artist, even a replica, can be used to find other locations where the painting is, or is associated with. Another example are natural phenomena whereby pictures of giant waterfalls taken at different locations get automatically associated to each other using image-based feature extraction, recognizing the waterfall in those various pictures. This method can be used in combination with other methods, such as textual or voice input, for example as users annotate the pictures by manually tagging features in the picture. For example a user taking a picture of an Italian coffee place can specify what it is. Other relevant media such as video, recorded sound or smell can use similar feature extraction techniques to find similarities among locations.

Another method analyses the similarity between the queries themselves so that users searching for the similar terms, speaking similar words into the device or uploading similar pictures implicitly provide hints to the system that their current locations are related. This approach relies on crowdsourcing as a means to verify that locations have a weaker or stronger similarity factor by looking at the number of similar queries at a location, and in proportion to other locations. A time factor can be applied whereby the association is stronger in proportion to the synchronicity of the queries coming from different locations.

By extension, similar conversations taking place at different locations can also be used as a similarity factor by analyzing the words in the messages or voice conversations.

Another method involves pre-computing clusters using unsupervised clustering techniques such as k-means clustering, matrix factorization, hierarchical agglomerative clustering, latent semantic analysis or any other method. Subsequently the clusters can be merged together to form larger sets using explicit inputs directly provided by users such as the ones mentioned in the embodiments described above. Implicit inputs such as current location or the others mentioned above can also affect merging. For example the user being present at a location of a first cluster while mentioning in a conversation terms strongly associated with another cluster could influence the merging to a degree. With enough inputs, the clusters can be merged in a fashion that follows their usage. Another method uses soft-assignment for ambiguous locations whereby locations can be soft-assigned to a cluster using a weight, and whereby the location can be part of multiple clusters. The final association of the location to a single cluster can for example be a factor of user inputs such as the ones mentioned in previous embodiments. The same process applies in the case that the similarity is first determined using other similarity techniques such as the ones mentioned above which do not necessarily have to form clusters but which for example determine the similarity between any two locations in the system.

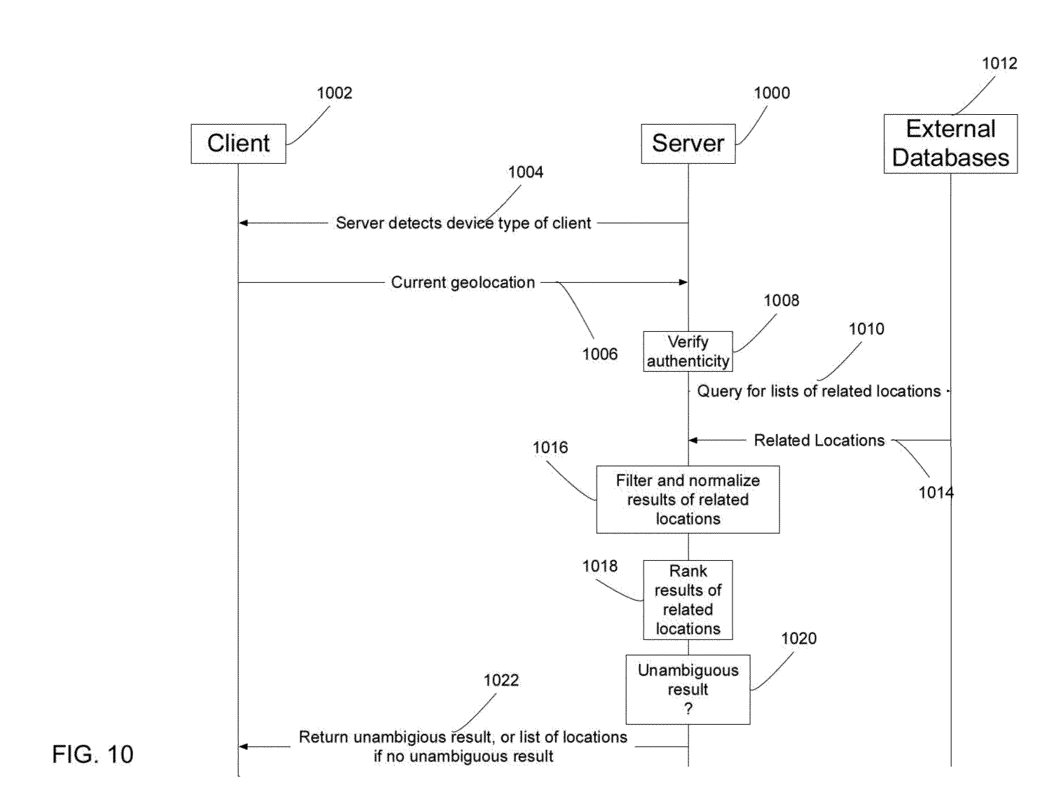

FIG. 10 is a diagram illustrating the spawning of multilocal services in accordance with an embodiment of the present invention. This diagram illustrates operations undertaken on a server 1000 as well as a client device 1002. In one embodiment, the client device 1002 is a mobile device such as a smartphone. At 1004, the server 1000 detects the device type of client device 1002. This may include, for example, classifying the client device 1002 as a mobile or desktop device. At 1006, the client device 1000 detects its current geolocation and sends this information to the server 1002. At 1008, the server 1000 then determines the authenticity of the location information provided by the client device 1002 using one or more security methods. At 1010, the server 1000 then queries one or more sources for a list of locations near the geolocation provided by the client. This may include, for example, querying various databases 1012, either locally or remotely over the Internet. At 1014, results are received from the databases 1012. At 1016, the server 1000 filters and normalizes the list of locations.

At 1018, the server 1000 ranks the results in the normalized list of locations using one or more features. Features may include, for example, proximity, user profile, feature set annotation (e.g., part of a popular cluster, often selected by other users which can potentially be similar users, users of the same market segment, nearby users, cohorts of users that connect at the same time, etc.). At 1020, the server 1000 determines if there is an unambiguous result for automatic selection. This may be the case if, for example, there is only one returned result, or if a scoring of the relevancy of results produces one location with a significantly higher score than other locations (and/or higher than a threshold score). At 1022, the server 1000 returns either the single unambiguous result (if there is one), or a list of locations from which the user may choose. The latter may be either the complete normalized list of locations that the server determined, or it may be filtered such that only top results are returned.

The returned list can also be personalized by applying knowledge extracted from the user's profile such as activity history, personal preferences or settings, personal information, contact information or other type of information entered by the user explicitly or implied using analysis techniques such as behavioral analysis.

The client may then select a result from the returned list (or approve the single unambiguous result), and then send back the selected result or approval.

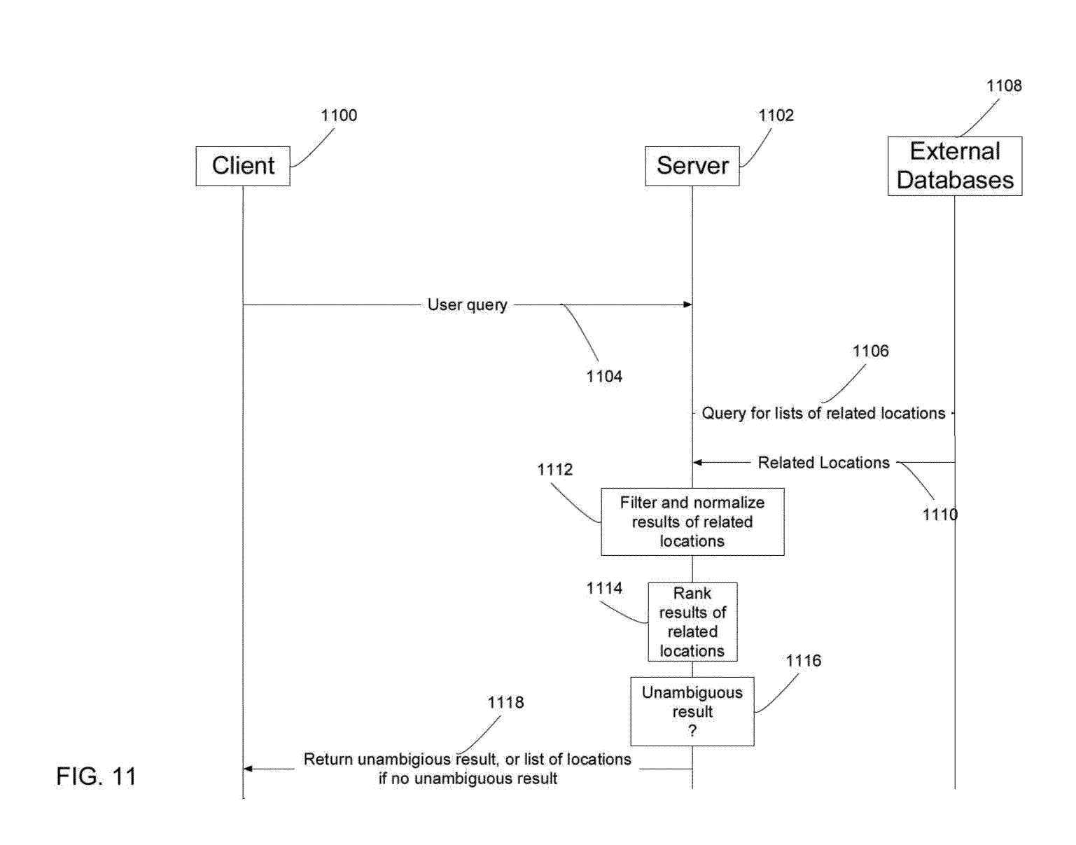

FIG. 11 is a diagram illustrating the spawning of multilocal services in accordance with another embodiment of the present invention. Here, rather than utilizing the geolocation of the client device 1100, the server 1102 utilizes a query generated at the client device 1100 in order to determine relevant locations. This may be most useful in cases where geolocation information may not be available, such as with non-mobile client devices, although one of ordinary skill in the art will recognize that this same technique could be utilized with a mobile device.

At 1104, a user enters a query on client device 1100 using a combination of one or more user interfaces. These user interfaces may include, for example, a query string in a search box, an online map with a geolocation and range, a voice-search input, and image-search input, and the like. At 1106, the server 1102 queries one or more sources for a list of locations matching the query.

This may include, for example, querying various databases 1108, either locally or remotely over the Internet. At 1110, results may be received from the databases 1108. At 1112, the server filters and normalizes the list of locations.

At 1114, the server 1102 ranks the results in the normalized list of locations using one or more features. Features may include, for example, proximity, user profile, feature set annotation (e.g., part of a popular cluster, often proposed to other users, etc.). At 1116, the server 1102 determines if there is an unambiguous result for automatic selection. This may be the case if, for example, there is only one returned result, or if a scoring of the relevancy of results produces one location with a significantly higher score than other locations (and/or higher than a threshold score). At 1118, the server 1102 returns either the single unambiguous result (if there is one), or a list of locations from which the user may choose. The latter may be either the complete normalized list of locations that the server determined, or it may be filtered such that only top results are returned.

In order to enhance the user experience and provide the utility of navigation the returned list can be extended to nearby locations at a greater range, and for which the user may not have access privileges or unless, for example, the user actually visited the location prioritizing those locations. The returning of nearby locations can be seen in FIG. 3, described earlier.

The client may then select a result from the returned list (or approve the single unambiguous result), and then send back the selected result or approval.

The client may also select or otherwise provide one or more discriminating terms to further supervise the formation of the set of relevant locations. The one or more selected or otherwise provided terms are used to filter out locations for which this term is found to be relevant to a certain level.

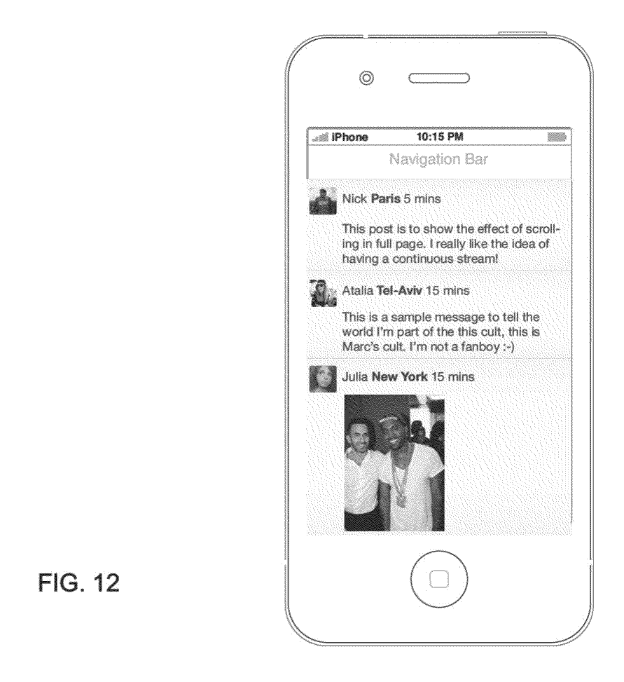

FIG. 12 is a diagram illustrating a user interface in accordance with another embodiment of the present invention. Here, the city is shown instead of a more precise geolocation, which provides additional privacy to users wishing to post messages or any other type of media. The messages and their respective users and (city) locations are depicted in this figure.

A number of example implementations will now be described. It should be noted, however, that these are merely examples and not intended to be limiting.

In one example, a homepage of a city's tourism board directs a user to information related to the user's particular location and related locations around the user. In another example, a community portal website associated with churches puts the user in touch with other religious practitioners or visitors present at any location of the church or related churches. This may include a form or chat room where such practitioners can interact.

In another example, parties listening to the same music in different locations can be provided with feedback and communications links among them. In a more precise example, the particular service might only be active at a set time, such as the launch day of a new album.

In another example, a group service to collectively watch sports events from participating bars and sports centers is provided. Participants can be connected using a stream of messages and updates specifically talking about the sports event and providing an interface for participants to provide feedback, commentary, place bids on their favorite teams, etc.

In another example, a service devoted to nature, species, and natural phenomenon is provided, wherein certain types of natural phenomenon that appear in multiple geolocations are grouped in such a away that visitors and tourists automatically get information about the local phenomena in relation to other phenomena at other geolocations. The service could even connect users observing different phenomena and different locations together so that they can make collective observations and appreciate similarities and differences. An extension of this service could be used in scientific research, using a variety of empirical techniques to capture data and characterize events in relation that wouldn't otherwise be associated (such as occurring at the exact same time or in relative synchronization to each other).

In another example, a worldwide tourist and aficionados educational channel for architecture and landmarks could provide real-time historical, cultural, and architectural information. The channel could be paid for as part of an educational or tourism program, or on a subscription basis granting access to professional information that could be provided by paid experts.

In another example, a multilocal website (or mobile application) for a brand could function as a way for the brand's customers to be connected to each other no matter what city and what franchise store of the brand at which they are located. All the brand's franchises could be connected to the brand's multilocal website in such a way that being nearby any of the brand's franchise locations would grant one access to its multilocal website. Such functionality could provide the brand with means to manage and communicate with its community of customers and fans, for the brand's sales representatives, store managers, clerks or marketing teams to answer questions by customers at or nearby any of their franchises, for the brand to diffuse product offerings, deals and specials as well as respond to comments, as well as for people to communicate among each other.

In another example, a multilocal function of a web site (or mobile application) that allows users to generate user-contributed sets of locations using, for example, automatic similarity to their current geolocation may be provided. A search interface such as text, image, or voice search or manual selection of geolocations can also be provided. The user can associate a website address, a path to online content or part of a website such that other users can be automatically connected to it when they find themselves at one of the geolocations of the associated set.

In another example, an official or non-official website or communication channel for commuting services, such as public transport, train, flights, etc. can be provided. The use of such a service could provide people ways to assist each other in troublesome situations, such as being at an airport and needing flight information regarding pending delays. The multilocal service would know at which airport the user is located and connect the user with appropriate travel information, relevant clerks or staff members, and potentially other consumers who can help find the right information.

In another example, a multilocal massive multiplayer online game (MMOG) could rely on players' geolocations to affect parameters inside the game. For example, rules or team assignments could be altered based on country. The multilocal set of associated geolocations could have predefined or user-assigned meaning inside the game in such a way that players that are nearby one or more of the geolocations can be differentiated from other players, for example they may earn points, rewards, or virtual currency that can be valuable and used inside or outside of the game.

In another example, a multilocal teleconferencing system, such as for video calls, can facilitate zero-setup calls between a plurality of geolocations or predefined locations. The advantage of zero setup is that the users have predefined the locations with which they wish to connect, so they do not need to dial or explicitly specify to the system what other geolocations they wish to be connected with. Other parameters can allow users to specify who they want to talk with more specifically (e.g. another or any other user at a specific location, that can be or not another location, of the same or another multilocal service; a 2-way audio or video call is then initiated) or limit access privileges to certain calls using authentication techniques.

### Attention-Based Score

In one embodiment of the present invention, a method of place valuation and ranking is provided. This method uses the fact that many places belong to a multilocation (e.g. a chain or brand), and that the value of this place is in part determined by the value of the other places in this multilocation. For instance, the valuation (and therefore ranking) of a place by users can automatically propagate to other places at different geolocations if/when they are part of the same multilocal set of places. Since a multilocal set is by definition formed in a meaningful way, any place of a set can assume a value more or less related to one or more other places of the same set. Therefore, activities related to one place can influence the value of another place, optionally with individual weights assigned to values propagating from one place to another based on one or more correlation factors that determine the strength of the propagation. The presented multilocal score propagation approach to place valuation and ranking requires less data, works faster and provides more accurate and meaningful scores that existing methods.

Furthermore, the system does not require users to disclose their actual geolocation to other users because it is sufficient that the multilocation is shared, therefore limiting disclosure. This process therefore aids with privacy concerns, which are a key problem for the adoption of location-based services. Instead of users having to disclose their actual location up front for the service to have value, using a multilocal service they do not since the valuable information (to other users) is that they are part of the same multilocal social group, and unlike other location-based social systems disclosing the geolocation is not required.

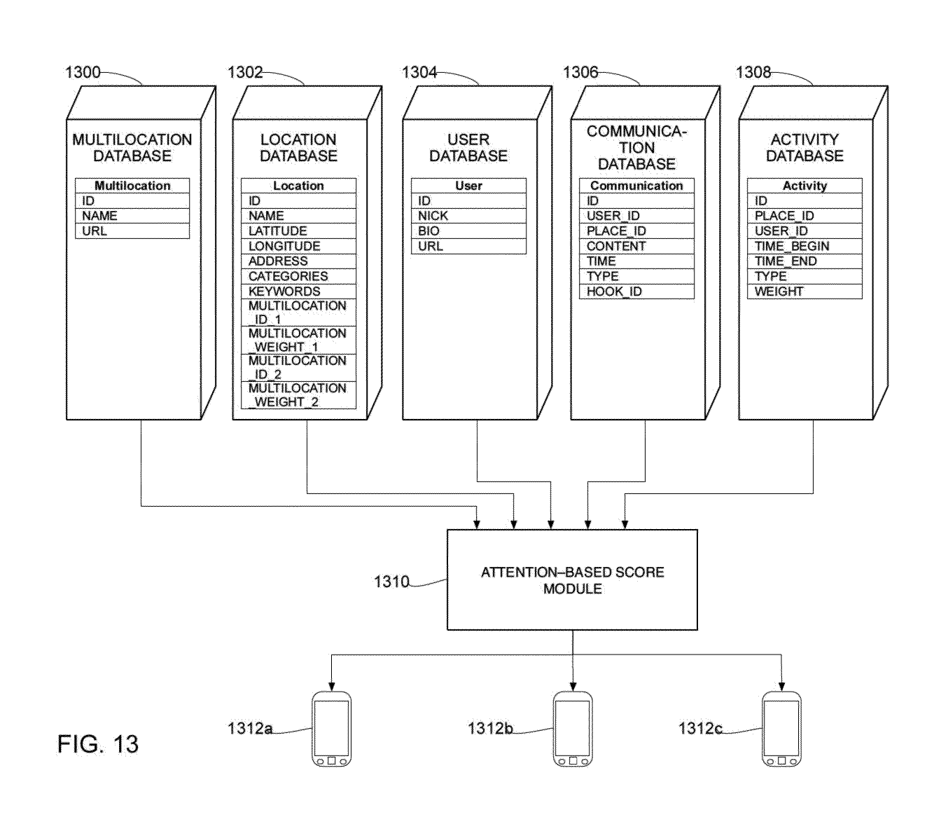

In an embodiment of the present invention, databases are provided, which can reside in a computer's memory or stored in a more permanent storage medium such as a hard disk. It could reside in a single computer system, or may distributed among different computer systems or by using cloud storage. These databases are depicted in FIG. 13. The databases include a multilocation database 1300, a location database 1302, a user database 1304, a communication database 1306, and an activity database 1308. The multilocation database 1300 contains a collection of multilocations. Each multilocation may have a plurality of associated locations that belong to that multilocation. Each multilocation may also include a series of associated information, such as the name of the multilocation, a web address for the multilocation, etc. The location database 1302 contains a collection of locations. Each location may include a series of associated information, such as geographic coordinates, addresses, names, contact information, hours of operations, etc. as well as one or more associated multilocations with corresponding weight factors.

The user database 1304 contains all the users of the system, each entry must have at least a unique identifier, other fields are optional. For example a user does not need to have a user account nor a personal profile to be able to use the system to communicate with other users in the same multilocal social networking group, he or she would do so anonymously. Optional fields such as name, bio, profile picture or other information provided by the user, automatically attributed by the system or added by other users is optional and not a requirement.

The communication database 1306 contains information about communications to and from the users. The activity database 1308 contains data on activities of users, related to locations and/or multilocations. Examples include users visiting certain locations, users sending messages from a particular location, users visiting locations concurrently with other users (using tracked time logs, for example), users interacting with other users at the location, etc. These stored elements can also be associated with a unique identifier for every user that allows the system to retrieve all actions performed by a specific user.

In an embodiment of the present invention, an attention-based score module 1310 is also provided. This module uses, among other thing, the data in the three databases described above to compute an attention-based score for every location in the location database 1302. One or more clients 1312a, 1312b, 1312c provide the attention-based score module 1310 with a location and receive from the attention-based score module 1310 the attention-based score for that location.

As described above, one or more clients 1312a, 1312b, 1312c provide the attention-based score module 1310 with a location and receive from the attention-based score module 1310 the attention-based score for that location. These clients 1312a, 1312b, 1312c can be software modules residing on the same or on different server, or can be other computer systems or electronic devices that connect to the attention-based score module via one or multiple communication channels. The various embodiments of the invention will give several examples of these clients.

In one embodiment of the present invention, a method to estimate the value of a location is provided, which accomplishes its goals by measuring how much attention users spend online, for example using their smartphone or other mobile device, while they are at the location in question or at another location that is related to it. Furthermore, in one embodiment, the value, also referred to as attention-based score, of one location is propagated to other locations that belong to the same multilocation.

The attention-based score module 1310, upon receiving a location from a client 1312a, 1312b, 1312c computes an attention-based score in part based on information drawn from the five databases 1300, 1302, 1304, 1306, 1308. The attention-based score module 1310 retrieves location information about the location from the location database 1302, the multilocation to which this location belongs to from the multilocation database 1300, the communication information from the communication database 1306, the information about the user from the user database 1304 and the user activity associated with said location, the multilocation, or other locations that belong to said multilocation from the user activity database 1308.

All the retrieved data is used to compute the attention-based score using various computational models, including, for example, linear interpolation, machine learning techniques, probabilistic models, support vector machines, or regression techniques.

A characteristic of this embodiment is that the computation of the attention-based score for a location takes into account the activity of users at the given location together with activity of users at other locations that belong to the same multilocation. This leads to a more accurate attention-based score compared to existing methods. In a connected world (or other system) the value of a location has a local aspect and a multilocal aspect to it. Both of these aspects are used to compute the value of a location.

In one embodiment of the present invention, a method is provided to estimate the value of a location by measuring the attention of users spent towards the location. Furthermore, a method to propagate attention spent on one location to other locations that belong to the same multilocation is also provided.

The attention-based score module, upon receiving a location from a client, can compute an attention-based score in part based on information drawn from the three databases. It can retrieve the location information from the location database, retrieve a multilocation to which this location belongs from the multilocation database, and retrieve the user activity associated with the location and the multilocation (as well as for other locations associated with the multilocation) from the user activity database.

All of this retrieved data can be aggregated and converted to the attention-based score. This aggregation and conversion can be performed using various computational models, including, but not limited to, linear interpolation, machine learning techniques, probabilistic models, support vector machines, and regression techniques.

The computation of the attention-based score for a location can take into account the activity of users at the location together with the activities of users at other locations belonging to the same multilocations. This leads to a more accurate attention-based score than prior art techniques.

In one embodiment, all the retrieved data can be aggregated and converted to a real number, representing the attention-based score. This score can then be used to more easily compare and rank locations.

In another embodiment, data in the user activity database is collected from a user with a geolocation system and an interaction system. A geolocation system is an electronic device or software module that measures, computes, or allows for the entry of the geographic location of a user or group of users. Examples of geographic locations include geographic coordinates, address, and landmarks. Example geolocation systems include GPS devices, terminals that allow the entry of geographic locations, wi-fi or RFID sensors, etc.

An interaction system is an electronic device that displays information to the user and that allows the user to interact with this information. The information can be nearby locations, the multilocations that the locations belong to, a list of users at the locations, a list of messages sent by users at the locations, etc. A user interaction can include selecting a location from the list of locations, selecting a multilocation from the list of multilocations, reading messages associated with a location and/or multilocation, sending a message that is associated with a location and/or multilocation, including an appreciation of other users, subscribing to messages of another user, etc.

The geolocation system and the interaction system need not reside on the same physical device or module.

In one embodiment every interaction of the user with the interaction system is registered in the activity database. The interaction system retrieves the current geographic location from the geolocation system and sends the interaction together with the geographic location via the communication channel to the user activity database and possibly to the user interactions database.

In one embodiment, the attention-based score is used for direct marketing and sponsored messages. The value of a place for its visitors is determined by how much, when and to whom a place has a meaningful purpose. Since the birth of the Internet new metrics provide a powerful means by which human behavior can be quantified and analyzed in order to understand what people do online, what their preferences are and what they want or need. These metrics keep evolving and bring increasingly accurate ways to model human behavior at a global scale and in real-time. The opportunity of mobile computing and pervasive Internet access using mobile devices (for example in modern cities) introduces geolocation as a new dimension providing insights as to where people like to spend their time and attention.

The value of a location, for example a piece of land or real estate, so far relies on traditional metrics such as for example the price of the real estate, the price of neighboring real estate properties, the condition of the location or of the surrounding space and its quality, where it is located in relation to other locations and their value, who wants to buy it and for how much, how the location is used, the potential future function of the location, etc.

Until recently recommender systems were primarily serving people with recommendations for products they might like based on their purchase and browsing history in the context of similar people who make the same choices and therefore have a similar taste. For example Amazon uses collaborative filtering techniques to recommend you books that people who read the same books as you have also bought. Nearest-neighbor methods make predictions for one user based on other nearby or similar choices made by other users. The more sophisticated methods rely on explicit feedback (i.e. purchases) but also implicit feedback (i.e. browsing, user interaction) to obtain a denser matrix and increase certainty. Other methods model latent factors for which subsets of users have more or less affinity. The state of the art is the winning entry of the Netflix Prize competition BellKor that applies such matrix factorization with added temporal dynamics to allow varying confidence levels of explicit feedback based on time-drifting preferences. Someone might like a movie now, in a particular context, at a given time of the day, year or following a particular event or other interaction, yet that preference might drift over time and with a change of context.

As mobile computing gets more pervasive there's a strong need for personalized context-based recommendations not just for products and media but also for physical locations, events and people that are currently relevant and context-sensitive. For example Foursquare would allow me to keep tabs on what venues and events my friends like to go to, and Google Places (previously known as Hot Pot) can drive place recommendations using factorization based on search history.

The problem with the current state of the art is that large amounts of data are needed for the proper modeling of human behavior with geolocation information. These large amounts of data are usually not available because people are not as mobile physically (for example in a city) as they are online, because people often do not wish to reveal their real geolocation because this is perceived as an unnecessary invasion of their privacy and as a potential security risk. Additionally, systems usually build up the dataset over a period of time, and suffer from the cold start problem in the beginning, where too little data produces a too sparsely populated matrix to make correct predictions.

These problems are encountered in different settings, by algorithms that use geolocation information to measure the value of a place or of a user, and by algorithms that use geolocation information to recommend places and/or users to other places and/or users based on the past activity patterns of the users. As such, an embodiment of the present invention aims to more accurately measure and track user attention.

In another embodiment of the present invention, a time variable is included that allows attention-based scores to vary in time with the purpose of obtaining more accurate attention-based scores for any given time. The time variable allows a multilocation to be qualified with an attention-based score that varies in time. Such variation accounts for changing activity patterns and attention spent for different moments of the day, different days of the week, different seasons, so on and so forth. For example a particular social networking group active at a multiplicity of night clubs might see stronger user activity, both at the location and coming from other locations of the same multilocation, in evenings and nights on weekend days, while it could be relatively less significant on week days. A subset of locations showing such trends might contribute to a higher score on Monday evening whereby they will rank higher within the set of locations of the multilocation in question, but also increase the total score of the multilocation on Monday evenings thereby affecting all its locations to a certain extent following an algorithm that allows such propagation of value among locations of the same multilocation.

As an extension to this embodiment, time zones can be applied to compensate for difference in clock times, for instance because of the relative different positions of the sun around the globe in a geographic space of coordinates. Depending on the application time zones can affect the score in a strict or more elastic fashion whereby a trend of a subset of locations affects the score of the multilocation (and therefore the propagated score at other locations of the same multilocation) for a longer time span to compensate and cover night times and weekends in more or less time zones. Such elasticity can be fully supervised or be learned using a variety of semi-supervised or non-supervised techniques to determine which elasticity matches best and provides most networking and information benefits to which application (or social networking group).

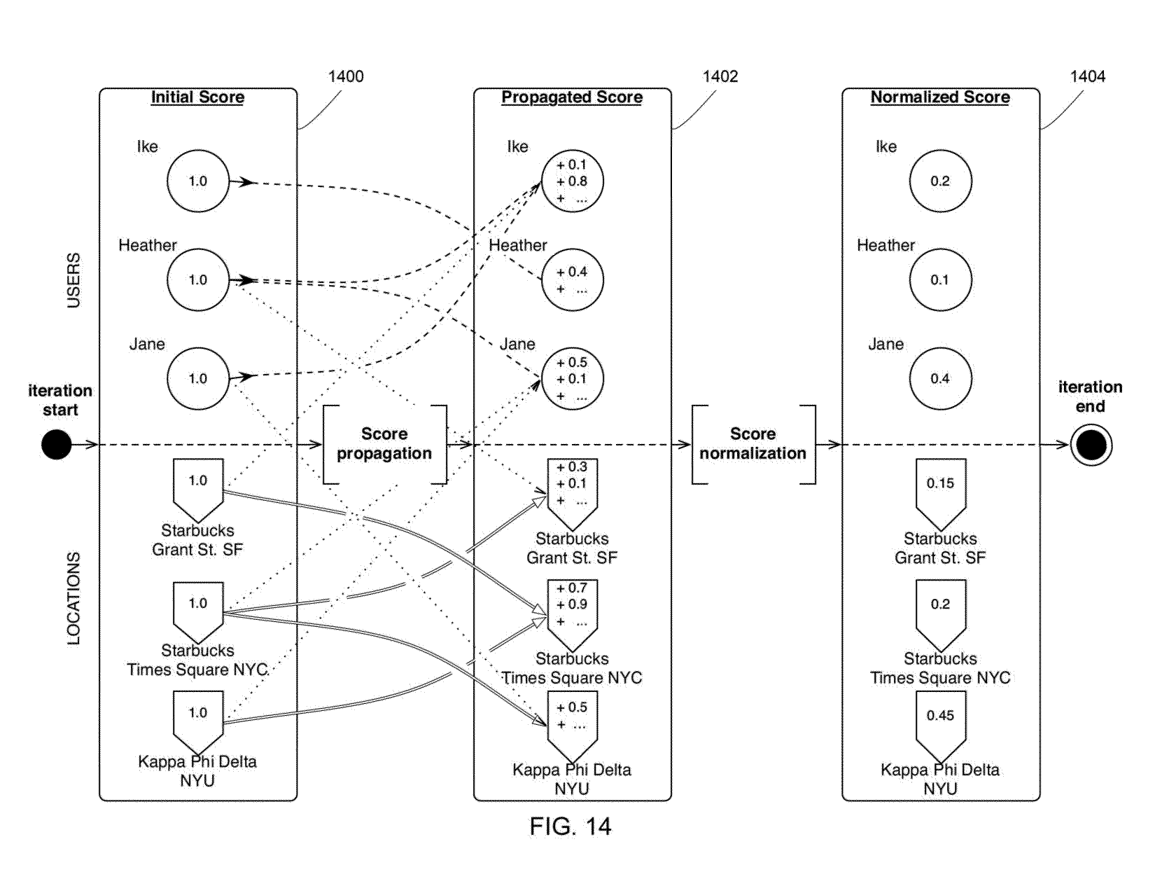

FIG. 14 is a diagram illustrating an algorithm for computing the attention-based score in accordance with an embodiment of the present invention. This algorithm is merely one example of such an algorithm, and one of ordinary skill in the art will recognize that other algorithms can be used in addition to or in lieu of this algorithm. This algorithm takes into account the implicit network of users (towards the top of each graph 1400, 1402, 1404) and locations (towards the bottom of each graph 1400, 1402, 1404). The goal of the algorithm is to compute a score for every location and every user that reflects how important the location/user is in the system. Importance can be defined using several different metrics and have thus a number of definitions, but generally correlates to the true amount of attention that users give to a particular location or user.

The attention of a user gives to a location can be measured by the amount of activity the user expends on the location, which can be measured by, for example, some or all of the following metrics:

(1) number of messages (or any other communication media) sent by a user at the location

(2) time spent by a user at the location

(3) number of visits of a user to the location (signaled explicitly using a ‘check-in’ or not)

(4) number of replies sent from a user while present at the location

(5) number of “follows” performed by a user while present at the location such as subscribing to messages of other users

(6) number of recurrent time-span overlaps between a user and another user while at least one user is present at the location e.g. how frequently and how long does a user spend jointly with another user at the location. The second user does not need to be at the same location but can simply be online from another location of the same multilocation. This gives us the viral and social traction metric on a per location basis. A location with a higher score than other locations of the same multilocation is the source of stronger ties among users and higher engagement from influential users.

(7) amount of time spent on activities regarding the location, after physically leaving the location e.g. a location with a high score is better at keeping users engaged after they have first physically visited the location. On another hand a location with a low score sees a higher churn rate whereby it is less sticky for its visitors since they do not stay engaged with the respective multilocation after the visit. This metric defines how elastic the influence of a location is for the multilocation it is part of in comparison to other locations.

In a first step algorithm to compute attention-based scores in this embodiment converts the simple metrics described above for a given location L, user U, and metric X to a single real number A (L, U, X). Thus, for example, A (L, U, 1) will be the number of posts sent by user U in location L.

The different metrics to capture the amount of activity of a user at a location can be converted into a single activity score. One example method would be to use linear interpolation:

$$A ( L , U {,}^{*} ) = {\sum }_{{x}_{i}} A ( L , U , {x}_{i} ) \times {w}_{i}$$

here wᵢ denotes the weight given to a particular metric, since some will be more important than others. The weights can either be set empirically by an administrator, or may be learned using input and output data (e.g. real live data of users visiting locations together with manual classifications of important locations).

The total activity of a user U spent at all locations can be computed as:

$$A {( }^{*} , U {,}^{*} ) = {\sum }_{L} A ( L , U {,}^{*} )$$

The total activity of all users at a single location L can be computed as:

$$A ( L {,}^{*} {,}^{*} ) = {\sum }_{U} A ( L , U {,}^{*} )$$

The total activity in the entire system can be computed as

$$A {( }^{*} {,}^{*} {,}^{*} ) = {\sum }_{U} A {( }^{*} , U {,}^{*} ) = {\sum }_{L} A ( L {,}^{*} {,}^{*} )$$

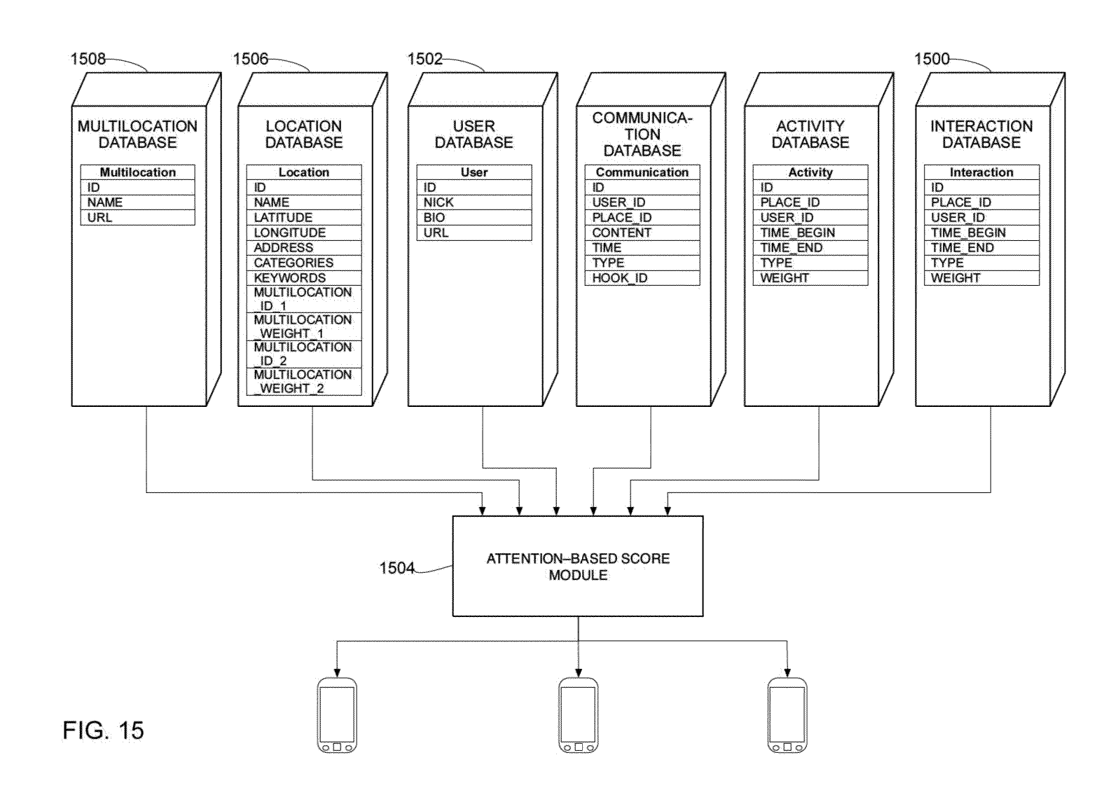

Another embodiment of the present invention is illustrated in FIG. 15. This figure is similar to FIG. 13, except with the addition of a user interaction database 1500 that is used to further refine the attention-based scores. This database is described as being separate from the user activity database 1502, although this can be or not be the case. The user interaction database captures the attention users give to other users by examining the amount of interaction between users, which can be measured, for example by, some or all of the following metrics:
(1) number of messages (or any other communication media) from user V read by user U
(2) number of replies of user U to a message of user V
(3) number of times user U indicated appreciation of a message (or any other communication media) of user V
(4) number of times user U viewed the profile (or any other property or description) of user V
(5) number of minutes that user U will has spent time in the same location as user V

In this embodiment, the computation of the attention-based score by the attention-based score module 1504 is in part based on information drawn from the location database 1506, from the multilocation database 1508, from the user activity database 1502 and from the user interaction database 1500. Upon receiving a location from a client, the attention-based score module 1504 retrieves information on the location from the location database 1506, retrieves information on the multilocation to which this location belongs from the multilocation database 1508, retrieves user activity associated with the location, the multilocation, or other locations that belong to the same multilocation, from the user activity database 1502 and retrieves information on user interaction associated with the location, the multilocation or other locations that belong to the same multilocation, from the user interaction database 1500.

This retrieved data is aggregated and converted to a real number, the attention-based score. This aggregation and conversion can be performed using various computational models, examples are, but are not limited to, linear interpolation, machine learning techniques, probabilistic models, support vector machines or regression techniques. Certain methods can be applied to optimize for compute time or accuracy depending on application needs, as well as mixtures of these various methods. This embodiment uses one particular method, i.e. linear interpolation, to compute attention-based scores for users and for locations including user interaction information.

A characteristic of this embodiment is that the computation of the attention-based score for a location takes into account the activity and interaction of users at the given location together with activity and interaction of users at other locations that belong to the same multilocation. This leads to a more accurate attention-based score compared to existing methods and a more accurate definition of the value users give to a location.

In one embodiment, the computational model for the aggregation and conversion of the data retrieved from the user activity database 1502 and from the user interaction database 1500 is as follows: every interaction Y is represented by a single real number B (U, V, Y) where user U is the originator of the interaction and V is the receiver, a single interaction score can be computed between two users U and V as follows:

$$B ( U , V {,}^{*} ) = {\sum }_{{y}_{i}} B ( U , V , {y}_{i} ) \times {w}_{i}$$

again, wᵢ denotes the weight assigned to a given metric. The linear interpolation thus computes the attention of user U spent on a certain user V by summing the values of the individual indicators, weighted by a value wᵢ. These weights allow the combination of stronger indicators of attention (e.g. a sign of appreciation of a message) with weaker ones (e.g. how much time spend at the same location). The weights can be set manually or can be learned automatically given input and output data (e.g. real live data of users visiting locations together with manual classifications of important locations). It should be noted that for interactions between users U and V that do not have a direction (e.g. are at the same location at the same point in time), two numbers of B (U, V, Y) of the same magnitude may be used. The total interaction originating from user U can be computed as:

$$B ( U {,}^{*} {,}^{*} ) = {\sum }_{V} B ( U , V {,}^{*} )$$

Finally, a variable C (L, M) can be introduced that indicates whether locations L and M belong to the same multilocation. So C (L, M)=1 if L and M belong to the same multilocation grouping (and are in different locations) and C (L, M)=0 otherwise.

$$C ( L {,}^{*} ) = {\sum }_{M} C ( L , M )$$

A score Q(U) can be computed for users and a score Q(L) for locations, which denote the importance of a user or location in the entire collection of users and locations. For users, the attention based score can be computed as follows:

$$Q ( U ) = {α}_{1} + {α}_{2} \times \frac{A ( U {,}^{*} {,}^{*} )}{A {(}^{*} {,}^{*} {,}^{*} )} + {α}_{3} \times {\sum }_{L} Q ( L ) \frac{A ( U , L {,}^{*} )}{A {( }^{*} , L {,}^{*} )} + {α}_{4} \times {\sum }_{V} Q ( V ) \frac{B ( V , U {,}^{*} )}{B ( V {,}^{*} {,}^{*} )}$$

This formula takes into account the raw activity score of the user, but also whether other important users interact with this user and whether the user is active in important locations. The variables a₁, a₂, a₃ and a₄ weight the relative value of these different factors. If a user with a high score, i.e. a user that visits locations of high scores and/or that spends a lot of time in general (and in overall pays high levels of attention) would interact with a low-score user located at a low-score location that is part of the same set of multilocations, the score of the second user would be further increased because of the high score of the first user, and the score of the location of the second user therefore would in turn further increase its score. This represents that when a strong user spends valuable time (and thus her or his attention) to a less valuable user, or to a less valuable user in a less valuable location, some of its value gets propagated to them.

For locations, the attention-based score can be computed as:

$$Q ( L ) = {α}_{4} + {α}_{5} \times \frac{A {( }^{*} , L {,}^{*} )}{A {( }^{*} {,}^{*} {,}^{*} )} + {α}_{6} \times {\sum }_{U} Q ( U ) \frac{A ( U , L {,}^{*} )}{A ( U {,}^{*} {,}^{*} )} + {α}_{7} \times {\sum }_{M} Q ( M ) \frac{C ( L , M )}{C {( }^{*} , M )}$$

This formula takes into account the raw activity score of the location, but also whether important users are active at the location and whether it belongs to the same multilocation grouping as other important locations.

Both of these formulas are recursive expressions, and in order for the solution to be stable the values of these expressions must converge after a number of iterations. In order to prove this, a square matrix N′ can be constructed and it can be shown that the scores correspond to the first eigenvector of the matrix.

Let N be a square matrix of dimensions (|L|+|U|)×(|L|+|U|) with |L| the number of locations and |U| the number of users. The diagonal elements in this matrix are 0. The other elements are:

$$N ( S , T ) = \frac{A ( U , L {,}^{*} )}{{\sum }_{M} A ( U , M {,}^{*} )} \times {α}_{2}$$

if s represents a user U (i.e, s≧|L|) and t a location L (i.e., t<|L|), or

$$N ( S , T ) = \frac{B ( U , V {,}^{*} )}{{\sum }_{W} B ( U , W {,}^{*} )} \times {α}_{3}$$

if s represents a user U (i.e, s≧|L|) and t a user V (i.e., s≧|L|), or

$$N ( S , T ) = \frac{A ( U , L {,}^{*} )}{{\sum }_{V} A ( V , L {,}^{*} )} \times {α}_{5}$$

if s represents a location L (i.e, s<|L|) and t a user U (i.e., t≧|L|), or

$$N ( S , T ) = \frac{C ( L , M )}{{\sum }_{N} C ( L , N )} \times {α}_{6}$$

if s represents a location L (i.e, s<|L|) and t a location M (i.e., t≧|L|), or
Let E be a square matrix of dimensions (|L|+|U|)×(|L|+|U|) with elements:

N(S,T)=A(*,L,*)×α₁

if s<|L| (t can have any value), or with elements:

N(S,T)=A(U,*,*)×α₁

if s≧|L| (t can have any value).
Let E be a square matrix of dimensions (|L|+|U|)×(|L|+|U|) with

N′=N+E

If c is a normalizing factor, the following holds for the score vector Q:

Q=cN′×Q

and Q is thus an eigenvector of N′. This shows that the expressions for the attention-based scores of users and for the attention-based scores of locations converges to stable value, and that they can be computed with any method that can be used to compute the eigenvector of a square matrix, such as the power iteration method.

### Tiered User Access

In another embodiment of the present invention, tiered user access is provided in location-based services. In the first tier, location-based user authentication is used. In a second tier, profile-based access to contents of a service is used.

Referring to the first tier, a client device may request access to a service active at the current geolocation of the user, among other locations. The server can then verify the authenticity of the device's geolocation using a plurality of anti-location-spoofing techniques. If the current geolocation is within a predefined range of one of a plurality of geolocations, then the authentication is successful and the user is granted access.

A user at a geolocation can be within a defined proximity range to one or more of a plurality of locations. The server can flag the device as being present at the location, add the device to a list of devices currently in proximity of one or more of the locations, and return to the device a plurality of services associated with those locations filtered by the user profile which it applied and ranked according to an algorithm that can be based on one or more parameters, such as the popularity of the service, the popularity of the location, the current popularity, etc.

The system can handle multiple users being within the range of multiple locations. A set of users individually present across a set of geolocations can all be connected to the same service.

The set of users currently present at a plurality of locations can also be further subdivided into subsets (either with or without overlaps), so that a particular subset has another experience or service than other subsets of people of the group. The service itself then can have a set of sub-services that is based on a certain condition, and the service can redirect an arbitrarily or algorithmically defined subset of the users to one of the sub-services. The parameters used to define subsets could be, for example, current or past geolocation history of the users, profile information, contact information among the users, activity patterns, subjects or topics extracted from the analysis of the content of the service, wish lists, planning, or local time of day, weather, etc.

Referring now to Tier-2, the level of activity here implies a level of access. A user's level of access is a function of the user's level of engagement with the service. User engagement is defined using a personal standard activity level in which the user is active. The more intense the activity in the particular service, in proportion to the user's standard activity level across all services, the stronger the engagement of the user with that service. A threshold can then be determined based on these factors, such that as long as the user's level of activity with the service exceeds the threshold, then the level of access is maintained. If the user's level of activity is dropped below this threshold, however, the access level can drop. In one embodiment of the present invention, a sunset countdown period is used to transition between the higher level of access and the lower level of access. The sunset period and the ultimate downgrading of access can be cancelled if the user's activity level increases above the threshold.

Activity level can be measured in different ways using different metrics related to the nature of the service. For example, in a communication service wherein users exchange messages, reading and posting messages are important interactions to measure, as well as metrics that describe the level of interaction with other users (e.g. time spent reading messages, total number of messages read per day, burst of activity per month, and the same for posting messages).

The access level can also mean different things for different services. Certain location-based services may want to restrict access to current and past visited geolocations of the user matching certain criteria. Other services may constrain access on time, content that is produced, or interactions that take place outside the user's own activity timespans.

The server logs user activity in a database, including details about the service, type of activity, timestamps, and geolocation. Then the server analyses user activity data using information retrieval techniques to extract activity pattern features, such as the user's engagement level with the service in proportion to other services, the user's temporal patterns, drops and bursts of activity, etc. The server can then run a classifier to cluster users by their behavioral patterns and annotate the clusters. The server then determines access-privacy thresholds for a user. For example, using the classifier the system could automatically determine a class of users that make extensive use of a service. Certain functionality of the service, for example of an online location-based game, could be available only to those users of that class, such as the ability to progress faster through the game or gain extra virtual energy. Users of that class might receive a special decoration that is recognized by other users, communicating their superior level of access. Users of that class might also have access to more files that are not accessible by users with a lower level of access due to their lower level of engagement.

### Multilocal Advertising

Once the value of a location is determined, by way of how much and how valuable is the local and multilocal attention spent at the location, it can be made tangible in different ways.

In the same way that the price of a billboard is valued in a physical world by the measured traffic of passers-by that get to see the billboard (pay attention to it), and in the same way that the price of a website (and the price of advertising on the website) is determined by the traffic of users of the website it generates, locations can be measured by how much traffic they generate locally and remotely using the attention score based on user activity and optionally user interaction.

The value of time in a specific location can now be more accurately measured using these new metrics that capture local and remote user activity connected to the location. This embodiment of this invention uses the attention-based score for the purpose of direct marketing and sponsored messages, or other business applications which can be provided both within the system or outside the system by the system or by third parties.

This valued time, as defined in the attention-based score of a location, can be sold to advertisers at a price that reflects better its value for local and remote users. It can be sold in different formats such as the placing of advertisement physically at the location, the placing of advertisement within the service targeted at the location, the placing of advertisement in a third party service such as an online service or mobile application, the placing of advertisement on a website related to the location or to its multilocation, the placing of advertisement on the page within the service that describes the location, the placing of information on the page within the service that describes the location, the placing of promoted or sponsored messages within a communication system between users such as within a stream of user generated messages and content, etc.

### Location-Based Virtual Currency

The valued time, as described earlier as being defined in the attention-based score of a location, can be also given back to the users in the form of a virtual currency which they can spend in exchange of services, goods or other currencies within or outside the system. They can also give the currency to other users within or outside the system, which they can use in turn. There can be a tax on the currency by which the system takes a commission on every unit of currency issued at a location. For example a sample business process could let the owner of a location, or the owner of multiple locations that are part of a multilocal set of locations, pay for currency issued and earned by its users. The owner would pay the company running the system a commission fee that can be a percentage share of the estimated financial value of the currency for each unit issued. In a geographic, or physical, context the virtual currency is earned by local, and potentially multilocal, attention spent by users and is therefore, at least in part, location-based. In addition, with the scarcity of time available for users, there's a location-based scarcity of how much currency can be issued because to generate the currency users need to spend time at the location or at another location of the same multilocal set of locations.

### Multilocal Classifier

In another embodiment of the present invention, a method for classifying users based on user activity patterns is presented. For example, geolocation data features can be used to determine groups of users with a similar behavior, also known as a segment. A segment is a subset of the users that form a market segment, for example a subset of the users of a service. Market segments are usually defined using explicit attributes such as gender, age, and preferences that are stated by the users and characteristics that are implied from their behavior. Behavioral analysis techniques are used, sometimes with training data sets, to annotate users and determine their segment. An annotation is a property of a user and need not be limited to a particular service or geolocation. Correlations can be found between annotations, for example, if they would directly or indirectly involve overlapping segments, using for example hierarchical or non-hierarchical clustering techniques.

The classifier can use a combination of one or more data sets (interaction data, profile data, geolocation, etc.), extract one or more features, and use one or more data mining techniques such as correlation matrices, dissimilarity clustering, support vector machine, machine learning techniques such as random forests, etc. to determine subsets of strong behavioral similarity. For example, in a service active at the global set of franchises of a brand, the classifier can be used to determine who is a clerk, who is a fan, who is a newbie, who is a tourist, who is a local, etc. by analyzing user activity patterns. The extracted subsets can be market segments that can be used for one or more monetization strategies such as brand-sponsored clerk accounts, targeting one or more segments with forms of advertising or promotion such as special deals for fans, store credit for brand advocates, gifts for newbies, badges for influencers, brand-promoted accounts, etc.

Certain classification techniques can be unsupervised, while others can be supervised. In one example embodiment, the classifier is supervised to extract a subset of users mostly active from one location and with overall activity strongly biasing towards one service, in order to determine a class of clerks that brands need to sponsor.

In another embodiment of the present invention, the classifier runs without predefined features and extracts key features that partition the data sets into classes of users with different behavioral attributes. For example, the classifier can distinguish between a segment of users that provide a lot of input to the service (savvy users, content producers, etc.) and another segment that is mostly consuming outputs (followers, content consumers, etc.). The classifier can be used to classify segments and provide target groups of users to an advertising or promotion module in order to customize ads, generate special deals, or promote certain products that match the target group or otherwise offer incentives adapted to the target group. In yet another embodiment of the present invention, brands can determine who their strongest brand advocates are using the classifier, in order to issue rewards of different kinds, such as badges or account credits, whereby a brand enters into a commercial engagement with brand advocates and issues financial rewards (potentially based on, or in proportion to, their activity level) using a transaction system, where the service acts as an intermediary facilitator.

### Multilocal Recommender

In one embodiment, relevant locations are recommended to users based on their past activity and possibly on their past interaction patterns. By employing the fact that locations belong to a multilocation, the presented invention requires less data regarding the user activity and regarding the user interaction to make accurate recommendations.

Given, for example, that user “John” has visited the “XYZ store” and “Central Computers” in San Francisco, we can predict the relevancy of the shop “ABC”, not only because other users in San Francisco who visited the “XYZ store” or “Central Computers” visited “ABC”, but also because users in others cities who visited the local “XYZ store” or “Central Computers” visited the local, or non-local, “ABC”.

This embodiment includes a recommendation module, which finds and ranks locations that are relevant to the user, based on the user's and others users' past activity and interaction patterns.

When the recommendation module receives a request from a client, together with a data item that uniquely identifies the user (for example a unique identifier within the system), it creates a list of locations that are relevant to the user and of users that are relevant to the user. These two lists are initially populated by retrieving from the user activity database the activity associated with the given user, and optionally by retrieving from the user interaction database the interactions associated with the given user.

In a second step, the list of relevant users is further refined by retrieving from the user activity database activity associated with any of the locations in the list of relevant locations, and to any of the multilocations of the locations in the list of relevant locations, and optionally from the user interaction database interactions associated with any of the users in the list of relevant users. The users thus retrieved are added to the list of relevant users, possibly weighted by a value that is based on a number of factors, for example on the information on the given user, on the current users in the list of relevant users or on the data retrieved from the user activity database.

In a third step, the list of relevant locations is further refined by retrieving from the user activity database activity associated with any of the users in the list of relevant users. The locations thus retrieved are added to the list of relevant locations, possibly weighted by a value that is based on a number of factors, for example on the information on the given user, on the current locations in the list of relevant locations or on the data retrieved from the user activity database.

The second and third steps can possibly be performed multiple times, either for a fixed number of iterations, or until a certain stopping criterion is met, for example a small change in the list of relevant locations or in the list of relevant users.

In the final step, the list of relevant locations is returned to the client.

A characteristic of this embodiment is that the computation of relevant locations employs the fact that locations belong to a multilocation and that this relation results in improved precision of the predictions.

In one embodiment, the recommendation module is used to find relevant users for a given user. The method in this embodiment is identical to the recommendation process described above, only in the final step the list of relevant users is returned instead of the list of relevant locations.

In one embodiment, the recommendation module is used to recommend, for a given user at a certain location, relevant locations that are located within a certain distance to the user.

In this embodiment, the location database includes for every location a geographic coordinate, examples of which are, but are not limited to, geographic coordinates (longitude and latitude), the address of the location, or a close-by landmark.

In one embodiment, the recommendation module receives a request from the client, together with a data item that uniquely identifies the user, a geographic coordinate that identifies the location of the user and a value that indicates the maximum range of locations that should be returned. The recommendation module then continues to find relevant locations. However, before returning the list of relevant locations to the client, for every location in this list, the geographic coordinate is retrieved from the locations database, the distance to the geographic coordinate of the user is computed, and if the distance is above the given maximum range, the location is removed. Only after thus filtering the list of relevant locations, it is returned to the client

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for multilocal implicit social networking, the method comprising:
receiving an indication of a first geolocation of a first user;
accessing a representation of a multilocal service, wherein the representation includes a plurality of locations, including locations different than the first geolocation, that are related to the multilocal service; and
when it is determined that the first geolocation matches one of the plurality of locations in the representation of the multilocal service, adding a social networking link between the user and the multilocal service.

2. The method of claim 1, further comprising:
receiving an indication of how long the first user is at the first geolocation; and
wherein the criteria established for the multilocal service includes a threshold amount of time a user must be present at a location for a social networking link to be added.

3. The method of claim 1, further comprising:
receiving an indication of how often the first user is at the first geolocation; and
wherein the criteria established for the multilocal service includes a threshold frequency of visits a user must make to a location for a social networking link to be added.

4. The method of claim 1, where the first user cannot gain access to the multilocal service unless the first geolocation matches one of the plurality of locations in the representation of the multilocal service.

5. The method of claim 1, wherein the adding includes determining that the user matches criteria established for the multilocal service.

6. The method of claim 1, wherein the representation is automatically constructed by examining bursts of user activity at geolocations.

7. The method of claim 1, further comprising:
removing the social networking link between the user and the multilocal service if the user fails to visit a geolocation matching one of the plurality of locations in the representation within a predefined period of time.

8. The method of claim 1, further comprising:
removing the social networking link between the user and the multilocal service if the user fails to visit a geolocation matching one of the plurality of locations in the representation for an aggregate amount of time within a predefined time period that is greater than a predefined threshold.

9. The method of claim 1, further comprising:
removing the social networking link between the user and the multilocal service if the user fails to visit a geolocation matching one of the plurality of locations in the representation with a frequency that exceeds a predefined threshold within a predefined period of time.

10. An implicit social networking service comprising:
memory storing a representation of a multilocal service wherein the representation includes a plurality of locations that are related to the multilocal service;
a geolocation interface designed to receive geolocations from devices operated by users;
a multilocal service matcher designed to determine whether geolocations from devices operated by users match one of the plurality of locations in the representation of the multilocal service and automatically add a social networking link between users of devices having matching geolocations and the multilocal service.

11. The implicit social networking service of claim 10, further comprising a classifier designed to automatically add locations to the representation based upon user activities detected at geolocations reported from the devices.

12. A system comprising:
a plurality of devices located in different geolocations;
an implicit social networking service designed to receive information regarding the geolocations of the plurality of devices and to group the plurality of devices into a single social grouping based upon the geolocations, and to automatically add social networking links between users of the devices in the social grouping.

13. The system of claim 12, wherein each of the plurality of devices includes an interface designed to allow a user to add a location to a grouping of geolocations.

14. The system of claim 13, wherein the location to add is derived from a search performed via the interface.

15. The system of claim 14, wherein the location to add is automatically determined based on a current location of the corresponding device.

16. The system of claim 15, wherein the implicit social networking service receiving an indication of how long the corresponding device is at the current location; and
wherein a criteria established for the implicit social networking service includes a threshold amount of time a user must be present at a location for a social networking link to be added.

17. The system of claim 12, wherein the implicit social networking service is further designed to remove a social networking link between the user and the multilocal service if the user fails to visit a matching geolocation within a predefined period of time.

18. The system of claim 12, wherein the implicit social networking service is located on a server.
